(19) United States
(12) Patent Application Publication
(10) Pub. No.: US 2024/0094409 A1
(43) Pub. Date: Mar. 21, 2024

(54) SYSTEM AND METHOD TO SYNCHRONIZE ACROSS POSITIONING RECEIVERS FOR SECONDARY CODE ACQUISITION

(71) Applicant: Apple Inc., Cupertino, CA (US)

(72) Inventors: Anjan Ramakrishnan, Cupertino, CA (US); Aditya N Srivastava, Fremont, CA (US); Harsha Shirahatti, Santa Clara, CA (US); Mojtaba Bahrami, San Jose, CA (US)

(21) Appl. No.: 18/220,729

(22) Filed: Jul. 11, 2023

Related U.S. Application Data
(60) Provisional application No. 63/407,037, filed on Sep. 15, 2022.

(51) Int. Cl. G01S 19/30

(52) U.S. Cl. CPC G01S 19/30

(57) ABSTRACT

A receiver device includes a first antenna, a second antenna, a first receiver, a second receiver, and processing circuitry. The first receiver is coupled to the first antenna and configured to receive a first signal from a Global Navigation Satellite System (GNSS) satellite via the first antenna. The second receiver is coupled to the second antenna and configured to receive a second signal indicative of a secondary code boundary corresponding to a secondary code in the first signal from a second receiver device via the second antenna. The processing circuitry is configured to receive a primary code by removing the secondary code from the first signal based on the secondary code boundary, perform coherent integration on the primary code, and output a geographic position of the receiver device based on the coherent integration.

### CROSS-REFERENCE TO RELATED APPLICATIONS

This application claims priority to U.S. Application No. 63/407,037, entitled “SYSTEM AND METHOD TO SYNCHRONIZE ACROSS POSITIONING RECEIVERS FOR SECONDARY CODE ACQUISITION,” filed Sep. 15, 2022, which is hereby incorporated by reference in its entirety for all purposes.

### BACKGROUND

The present disclosure relates generally to processing a signal (e.g., pilot signal) broadcast by a transmitter device (e.g., space vehicle, such as a satellite) in a Global Navigation Satellite System (GNSS). More specifically, the present disclosure relates to a receiver device (e.g., user equipment device, such as a mobile phone) configured to process the signal received from the transmitter device to determine a time of transmission (TOT) of the signal from the transmitter device, a time of arrival (TOA) of the signal at the receiver device, or both.

A GNSS may include a transmitter device (e.g., space vehicle, such as a satellite) configured to broadcast, via a carrier wave, a signal having a primary code and a secondary code. The primary code, the secondary code, or both may include pseudorandom code (e.g., a sequence of ones and zeros). A receiver device (e.g., user equipment device, such as a mobile phone) may receive and process the signal to determine a time of transmission (TOT) of the signal from the transmitter device, a time of arrival (TOA) of the signal at the receiver device, or both. The TOT and the TOA (and, in some embodiments, other information such as a position of the transmitter device) may be employed to determine a distance between the transmitter device and the receiver device. Further, the distance between the transmitter device and the receiver device, along with other information (e.g., additional distances between the receiver device and additional transmitter devices of the GNSS, a synchronized atomic clock, etc.), may be employed to determine a geographic position of the receiver device.

In traditional systems, the receiver device may process the signal received from the transmitter device via coherent integration, among other processing steps. Because the signal includes both the primary code and the secondary code, the coherent integration may be limited to only one period of the primary code, and sensitivity loss may be caused by a mismatch with a secondary code boundary of the secondary code. These challenges in traditional systems may render a result of the coherent integration inconclusive. Further, while traditional systems may employ various techniques to remedy the above-described challenges, such techniques may be time-consuming, resource exhaustive, and/or inadequate for signals with relatively poor signal strength. Further still, while non-coherent approaches may also employed in traditional systems, non-coherent approaches may be less accurate in determining the geographic position of the receiver device. Accordingly, it is now recognized that improved systems and methods for determining the geographic position of a receiver device via the GNSS are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a receiver device includes a first receiver, a second receiver, and processing circuitry. The first receiver is configured to receive a first signal from a Global Navigation Satellite System (GNSS) satellite. The second receiver is configured to receive a second signal indicative of a secondary code boundary corresponding to a secondary code in the first signal from a second receiver device. The processing circuitry is configured to receive a primary code by removing the secondary code from the first signal based on the secondary code boundary, perform coherent integration on the primary code, and output a geographic position of the receiver device based on the coherent integration.

In another embodiment, one or more tangible, non-transitory, computer-readable media includes instructions stored thereon that, when executed by one or more processors, are configured to cause the one or more processors to perform various functions. The functions include receiving a first signal from a Global Navigation Satellite System (GNSS) satellite via a first antenna and a first receiver coupled to the first antenna, and receiving a second signal indicative of a secondary code boundary corresponding to a secondary code in the first signal from a navigating device via a second antenna and a second receiver coupled to the second antenna. The functions also include receiving a primary code of the first signal by removing the secondary code from the first signal based on the secondary code boundary, and outputting a geographic position of a receiver device based on coherent integration of the primary code.

In yet another embodiment, a method includes receiving signals transmitted by Global Navigation Satellite System (GNSS) satellites via one or more antennas of a first electronic device and one or more receivers coupled to the one or more antennas. The method also includes determining a geographic position of the first electronic device based on the signals and via processing circuitry coupled to the one or more receivers. The method also includes outputting, to a second electronic device, a facilitating signal including data indicative of a secondary code boundary of a secondary code corresponding to at least one signal signals transmitted by the GNSS satellites.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic illustration of a Global Navigation Satellite System (GNSS) configured to facilitate identification of a geographic position of the electronic device of FIG. 1 based on a first signal received by the electronic device from a transmitter device (e.g., space vehicle, such as a satellite) of the GNSS and a second signal received by the electronic device via a navigating device, according to embodiments of the present disclosure;

FIG. 4 is a schematic illustration of a GNSS configured to facilitate identification of a geographic position of the electronic device of FIG. 1 based on a first signal received by the electronic device from a transmitter device (e.g., space vehicle, such as a satellite) of the GNSS and a second signal received by the electronic device via a base station (e.g., cellular tower), according to embodiments of the present disclosure;

FIG. 5 is a schematic illustration of logic employed at the electronic device of FIG. 1 to determine a time of transmission (TOT) of the first signal from the transmitter device of the GNSS of FIG. 3, a time of arrival (TOA) of the first signal at the electronic device, or both based on processing steps involving the second signal received by the electronic device via the navigating device, according to embodiments of the present disclosure; and

FIG. 6 is a schematic illustration of a communicative coupling between the electronic device of FIG. 1 and the navigating device of the GNSS of FIG. 3, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

The present disclosure relates generally to processing a signal (e.g., pilot signal) transmitted by a transmitter device (e.g., space vehicle, such as a satellite) in a Global Navigation Satellite System (GNSS). More specifically, the present disclosure relates to a receiver device (e.g., user equipment device, such as a mobile phone) configured to process the signal received from the transmitter device based at least in part on an additional signal received from an additional receiver device (e.g., additional user equipment device, such as an additional mobile phone, or base station, such as a cellular tower). In doing so, the receiver device may determine a time of transmission (TOT) of the signal from the transmitter device, a time of arrival (TOA) of the signal at the receiver device, or both. As described in detail below, a geographic position of the receiver device may be determined based on the TOT and the TOA a time of arrival (TOA). Other information may also be employed to determine the geographic position of the receiver device (e.g., a GNSS synchronized atomic clock, data relating to TOTs and/or TOAs of signals emitted by other transmitter devices of the GNSS, position information of the transmitter device(s), etc.).

In accordance with the present disclosure, the transmitter device may broadcast the signal via a carrier wave. The receiver device may wipe off, remove, or extract aspects of the carrier wave based at least in part on a local oscillator, thereby isolating a primary code and a secondary code of the signal. In some embodiments, noise may accompany the primary code and the secondary code after the receiver device wipes off aspects of the carrier wave. The primary code, the secondary code, or both may be referred to as pseudorandom code (e.g., including a sequence of ones and zeros). The receiver device may correlate (e.g., time-align) the primary code with a replica primary code locally generated at the receiver device. Further, the receiver device may receive an additional signal via an additional receiver device (e.g., additional user equipment, such as an additional mobile phone, or base station, such as a cellular tower). In instances where the additional receiver device includes the user equipment (e.g., a mobile phone), the additional receiver device may be referred to as a “navigating device” because a geographic position of the additional receiver device may be known. In instances where the additional receiver device includes the base station, the base station may receive the additional signal from user equipment (e.g., a mobile phone) and relay the additional signal to the receiver device. Alternatively, the base station may generate the additional signal independent from user equipment (e.g., a mobile phone). Further, it should be noted that a geographic position of the base station may be fixed and known. In this way, the base station may be referred to as a “navigating device” because the geographic position is known, despite the geographic position being fixed.

The additional signal received at the receiver device may include data indicative of a secondary code boundary, time tagged space vehicle information, and/or other information. The receiver device may employ the additional signal received from the additional receiver device to wipe off, remove, or extract the secondary code at the receiver device prior to coherent integration at the receiver device. In doing so, unlike traditional embodiments, the coherent integration at the receiver device may not be limited to only one period of the primary code. Extending the coherent integration may produce more conclusive results, especially with respect to signals having a weaker signal strength. In general, the receiver device may perform the above-described processing steps, including the coherent integration, to determine characteristics of the transmitter device and/or the signal transmitted by the transmitter device and received by the receiver device, such as a time of transmission (TOT) of the signal from the transmitter device, a time of arrival (TOA) of the signal at the receiver device, or both. A time difference between the TOT and the TOA may be employed to determine a distance between the transmitter device and the receiver device, which may be employed to determine a geographic position of the receiver device based on the TOT and the TOA. Other information may also be employed to determine the geographic position of the receiver device, such as TOTs, TOAs, and time differences therebetween corresponding to other signals broadcast by other transmitter devices (e.g., space vehicles, such as satellites) of the GNSS, positions of the various transmitter devices, etc. These and other features are described in detail below with reference to the drawings.

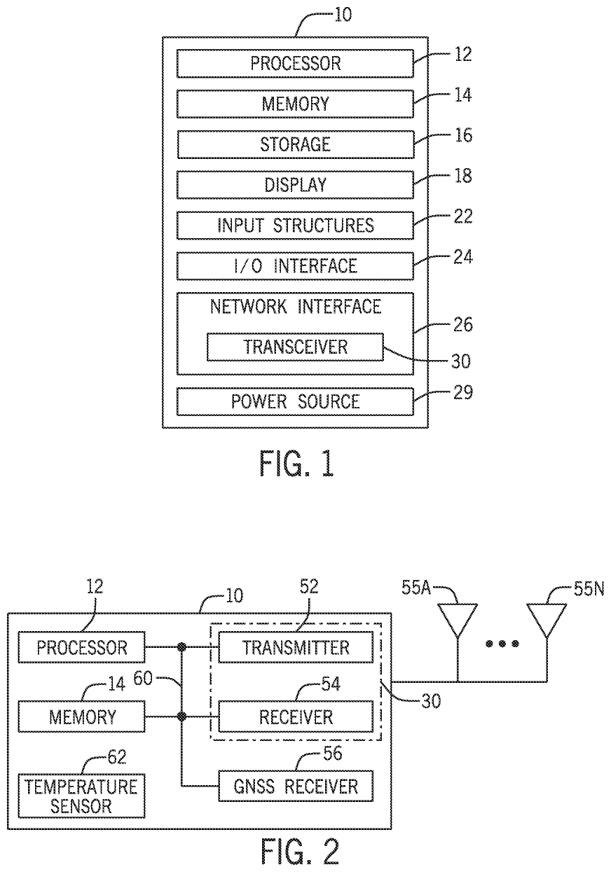

With the foregoing in mind, FIG. 1 is a block diagram of an electronic device or mobile communication device 10, according to embodiments of the present disclosure. The electronic device 10 may be referred to in certain instances of the present disclosure as a user equipment device. The electronic device 10 may include, among other things, one or more processors 12 (collectively referred to herein as a single processor for convenience, which may be implemented in any suitable form of processing circuitry), one or more memories 14 (collectively referred to herein as a single memory for convenience, which may be implemented in any suitable from of memory circuitry), nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions), or a combination of both hardware and software elements (which may be referred to as logic). The processor 12, the memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive data between one another. It should be noted that FIG. 1 is merely one example of a particular implementation and is intended to illustrate the types of components that may be present in electronic device 10.

By way of example, the electronic device 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be generally referred to herein as “data processing circuitry.” Such data processing circuitry may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may perform the various functions described herein.

In the electronic device 10 of FIG. 1, the processor 12 may be operably coupled with the memory 14 and the nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol.

The network interface 26 may include, for example, one or more interfaces for a terrestrial (e.g., land-based) network or non-terrestrial network (NTN), a peer-to-peer (P2P) connection, a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or for a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, and so on.

The network interface 26 can further communicate via NTNs, or segments of such networks, using an airborne or spaceborne vehicle (e.g., satellite) for transmission. As used herein, airborne vehicles refer to High Altitude Platforms (HAPs) encompassing satellites, Unmanned Aircraft Systems (UAS)—including tethered UAS, Lighter than Air UAS and Heaver than Air UAS—operating at altitude; typically between 8 and 50 kilometers, quasi stationary. In particular, the network interface 26 may include, for example, one or more interfaces for using a cellular communication standard of the 5G specifications that include the millimeter wave (mmWave) frequency range (e.g., 24.25-300 gigahertz (GHz)). The network interface 26 of the electronic device 10 may allow communication over the aforementioned networks (e.g., 5G, Wi-Fi, LTE-LAA, and so forth). The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, UWB network, alternating current (AC) power lines, and so forth. The network interface 26 may, for instance, include a transceiver 30 for communicating data using one of the aforementioned networks. The power source 29 of the electronic device 10 may include any suitable source of power, such as a rechargeable lithium polymer (Li-poly) battery and/or an alternating current (AC) power converter.

FIG. 2 is a functional diagram of the user equipment 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55), and/or a global navigation satellite system (GNSS) receiver 56 may be communicatively coupled directly or indirectly (e.g., through or via another component, a communication bus, a network) to one another to transmit and/or receive signals between one another.

The user equipment 10 may include the transmitter 52 and/or the receiver 54 that respectively transmit and receive signals between the user equipment 10 and an external device via, for example, a network (e.g., including base stations) or a direct connection. As illustrated, the transmitter 52 and the receiver 54 may be combined into the transceiver 30. The user equipment 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The user equipment 10 may include multiple transmitters, multiple receivers, multiple transceivers, and/or multiple antennas as suitable for various communication standards. For example, the user equipment 10 may include a first transceiver to send and receive messages using a first wireless communication network, a second transceiver to send and receive messages using a second wireless communication network, and a third transceiver to send and receive messages using a third wireless communication network, though any or all of these transceivers may be combined in a single transceiver. In some embodiments, the transmitter 52 and the receiver 54 may transmit and receive information via other wired or wireline systems or means.

The user equipment 10 may include the GNSS receiver 56 that may enable the user equipment 10 to receive GNSS signals from a GNSS network that includes one or more GNSS satellites or GNSS ground stations. The GNSS signals may include a GNSS satellite's observation data, broadcast orbit information of tracked GNSS satellites, and supporting data, such as meteorological parameters, collected from co-located instruments of a GNSS satellite. For example, the GNSS signals may be received from a Global Positioning System (GPS) network, a Global Navigation Satellite System (GLONASS) network, a BeiDou Navigation Satellite System (BDS), a Galileo navigation satellite network, a Quasi-Zenith Satellite System (QZSS or Michibiki) and so on. The GNSS receiver 56 may process the GNSS signals to determine a global position of the user equipment 10. In general, the GNSS receiver 56 may be coupled to one or more of the antennas 55A-55N of the user equipment 10, and the receiver 54 may be coupled to one or more other of the antennas 55A-55N of the user equipment 10.

As illustrated, the various components of the user equipment 10 may be coupled together by a bus system 60. The bus system 60 may include a data bus, for example, as well as a power bus, a control signal bus, and a status signal bus, in addition to the data bus. The components of the user equipment 10 may be coupled together or accept or provide inputs to each other using some other mechanism.

The user equipment 10 may include a temperature sensor 62 to measure temperature of certain components (e.g., an oscillator) of the user equipment 10. In some cases, changes in temperature may alter a crystal regulating the oscillator, causing oscillator drifts or crystal drifts. Such crystal drifts may lead to undesired progressive changes in time. The user equipment 10 may keep track of the crystal drifts based on estimating the crystal drifts using temperature reading of the temperature sensor 62.

As discussed above, the user equipment 10 may transmit a signal, via the transmitter 52, directed to a communication node for subsequent transmission to a communication hub. For example, the user equipment 10 may transmit different signals at a transmission power to enable successful receipt of the signals by the communication node. However, in response to determining that the communication node does not successfully receive the signal (e.g., due to a non-functional reverse beam), the user equipment 10 may switch to a second communication node and re-transmit the signal to the second communication node, such as until the user equipment 10 determines that the second communication node successfully receives the signal (e.g., in response to receipt of an acknowledgement signal from the second communication node).

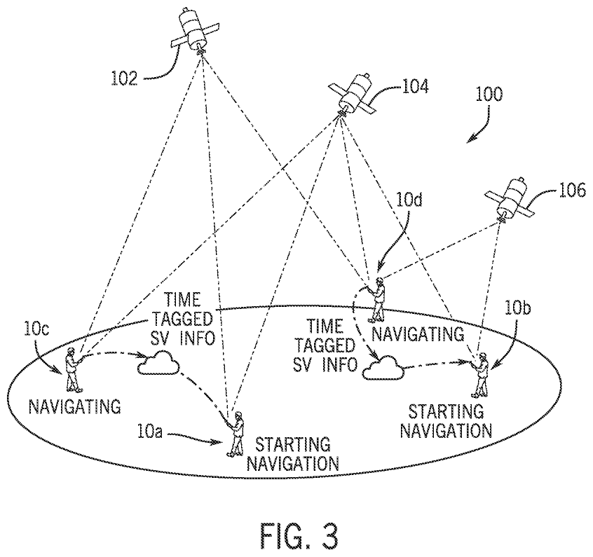

FIG. 3 is a schematic illustration of an embodiment of a Global Navigation Satellite System (GNSS) 100 configured to facilitate identification of a geographic position of the electronic device 10 of FIG. 1. In the illustrated embodiment, multiple electronic devices 10 are shown, including a first electronic device 10a, a second electronic device 10b, a third electronic device 10c, and a fourth electronic device 10d. The third electronic device 10c and the fourth electronic device 10d may be referred to as “navigating devices” because geographic positions thereof are known. In some embodiments, the third electronic device 10c and the fourth electronic device 10d may determine their respective geographic positions without receiving facilitating signals from other electronic devices or terrestrial base stations (e.g., based only on processing various signals received from various transmitter devices, such as space vehicles or satellites, of the GNSS 100). Additionally, it should be noted that the first electronic device 10a, the second electronic device 10b, the third electronic device 10c, and the fourth electronic device 10d may be referred to as “receiver devices” in certain instances of the present disclosure.

The GNSS 100 may include a first transmitter device 102 (e.g., a first space vehicle, such as a first satellite), a second transmitter device 104 (e.g., a second space vehicle, such as a second satellite), and a third transmitter device 106 (e.g., a third space vehicle, such as a third satellite). The first transmitter device 102, the second transmitter device 104, and the third transmitter device 106 each may broadcast a respective signal received by the various ones of the electronic devices 10a, 10b, 10c, 10d, as shown. Although only three transmitter devices 102, 104, 106 are shown in the illustrated embodiment, it should be understood that additional transmitter devices may also be employed in the GNSS 100. Indeed, signals from four or more transmitter devices may be required in certain instances or conditions to ascertain a geographic position of a receiver device. Alternatively, signals from three transmitter devices and a GNSS synchronized atomic clock may be employed in certain instances or conditions to ascertain a geographic position of a receiver device. In general, an accuracy of the geographic position may be improved as a number of transmitter devices (and corresponding signals) interfacing with the receiver device increases.

As previously described, geographic positions of the third electronic device 10c and the fourth electronic device 10d may be known, whereas geographic positions of the first electronic device 10a and the second electronic device 10b may have been requested but are unknown. In accordance with the present disclosure, the first electronic device 10a may receive an additional signal from the third electronic device 10c. In some embodiments, an intermediate translation unit may be employed between the first electronic device 10a and the third electronic device 10c, such that the third electronic device 10c transmits the additional signal to the intermediate translation unit, which processes or otherwise modifies the additional signal prior to relaying it to the first electronic device 10a. As will be appreciated in view of later drawings, the first electronic device 10a may employ one or more signals received from one or more of the transmitter devices 102, 104, 106 and one or more additional signals received from the third electronic device 10c to determine a geographic position of the first electronic device 10a.

Further to the points above, the second electronic device 10b may receive an additional signal from the fourth electronic device 10d. In some embodiments, an intermediate translation unit may be employed between the second electronic device 10b and the fourth electronic device 10d, such that the fourth electronic device 10d transmits the additional signal to the intermediate translation unit, which processes or otherwise modifies the additional signal prior to relaying it to the second electronic device 10b. As will be appreciated in view of later drawings, the second electronic device 10b may employ one or more signals received from one or more of the transmitter devices 102, 104, 106 and one or more additional signals received from the fourth electronic device 10d to determine a geographic position of the second electronic device 10b.

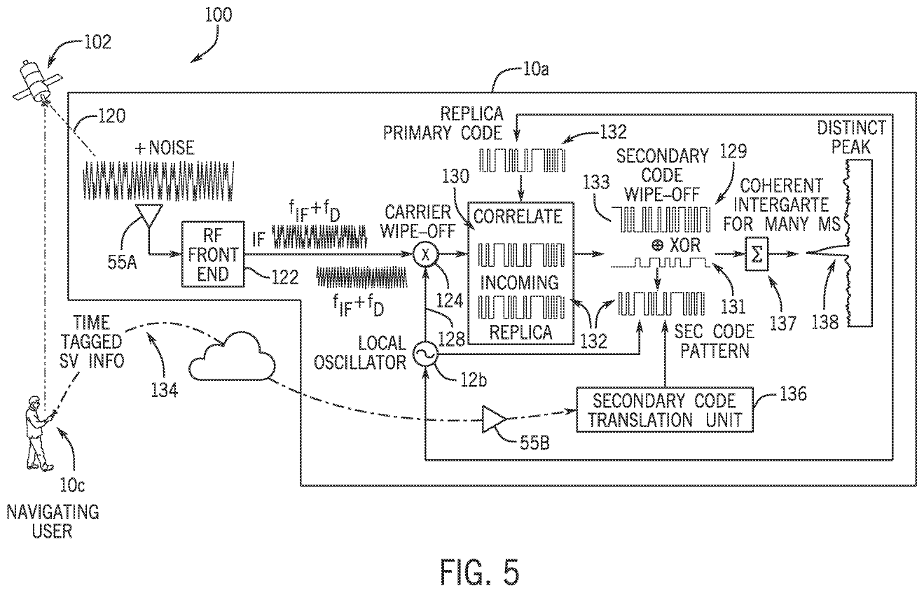

In general, the first electronic device 10a may be configured to receive the additional signal from the third electronic device 10c (or from the intermediate translation unit) when the first electronic device 10a and the third electronic device 10c are within a threshold distance of each other (e.g., less than 150 kilometers, or less than 200 kilometers). Likewise, the second electronic device 10b may be configured to receive the additional signal from the fourth electronic device 10d (or from the intermediate translation unit) when the second electronic device 10b and the fourth electronic device 10d are within a threshold distance of each other (e.g., less than 150 kilometers, or less than 200 kilometers). Specific aspects of the signal processing at the first electronic device 10a and/or the second electronic device 10b (e.g., to determine geographic positions thereof) will be described in detail with reference to FIG. 5.

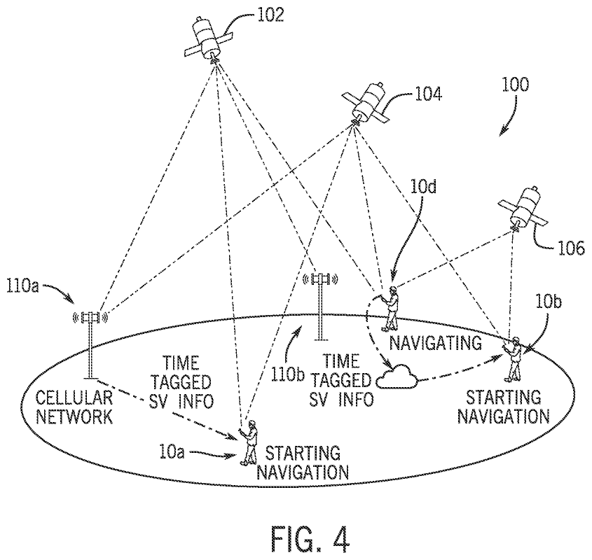

In FIG. 3, the first electronic device 10a, the second electronic device 10b, the third electronic device 10c, and the fourth electronic device 10d may correspond to user equipment devices, such as mobile phones. However, the third electronic device 10c and the fourth electronic device 10d, in another embodiment, may be replaced by base stations (e.g., cellular towers) configured to receive the signals from various ones of the transmitter devices 102, 104, 106 of the GNSS 100. As an example, FIG. 4 is a schematic illustration of an embodiment of the GNSS 100 in which the third electronic device 10c is replaced by a first base station 110a (e.g., terrestrial base station, such as a cellular tower). In the illustrated embodiment, the first electronic device 10a is configured to receive the additional signal from the base station 110a. In some embodiments, the base station 110a may relay the additional signal to the first electronic device 10a from an additional electronic device, or the base station 110a may generate the additional signal independent from an additional electronic device. Employing the base station 110a may provide an advantage in that the base station 110a is fixed and a geographic position thereof need not be periodically calculated. The additional signals received by the first electronic device 10a and the second electronic device 10b, employed in conjunction with the signals received from various ones of the transmitter devices 102, 104, 106, may include information known to the sources of the additional signals (e.g., base stations and/or additional receiver devices, as previously described), such as time tagged space vehicle information and/or other information indicative of secondary code boundaries corresponding to secondary code contained in the signals received from the transmitter devices 102, 104, 106. Specific aspects of the signal processing at the first electronic device 10a and/or the second electronic device 10b (e.g., to determine geographic positions thereof) will be described in detail with reference to FIG. 5.

FIG. 5 is a schematic illustration of an embodiment of logic employed at the electronic device 10a to determine a time of transmission (TOT) of a first signal from the transmitter device 102 of the GNSS 100, a time of arrival (TOA) of the first signal at the electronic device 10a, or both based on processing steps involving a second signal received by the electronic device 10a from the navigating device 10c. It should be noted that “logic,” as used herein, may refer to hardware, software, or both employed to process (e.g., analyze, modify, synthesize, extract data from, and so on) various signals as described below.

In the illustrated embodiment, the electronic device 10a receives, via antenna 55A, a first signal 120 transmitted (e.g., via a carrier wave) from the transmitter device 102 of the GNSS 100. It should be noted that reference to “the first signal 120” may be employed below with respect to certain processing stages despite the first signal 120 being transformed, decoded, manipulated, or otherwise processed via various aspects of the electronic device 10a. The first signal 120 may pass through radio frequency (RF) front end circuitry 122, which may process the first signal 120 at an incoming RF before it is converted to a lower intermediate frequency (IF). Thereafter, the first signal 120 may be received at a mixer 124 of the electronic device 10a. The mixer 124 may also receive, from a local oscillator 126 of the electronic device 10a, a local oscillator signal 128. In general, the mixer 124 may be configured be to wipe off, remove, or extract aspects of the carrier wave from the first signal 120 based on the local oscillator signal 128. In doing so, for example, a combination 129 of a primary code 130 and a secondary code 131 of the first signal 120 may be isolated from carrier wave aspects of the first signal 120.

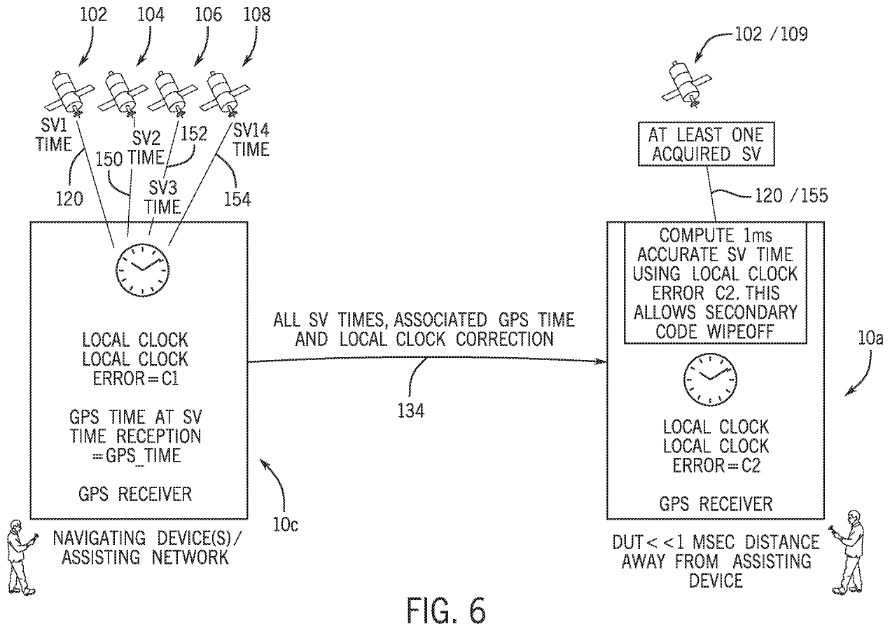

Following the carrier wipe off described above, the primary code 130 is correlated (e.g., time-aligned) with a replica primary code 132 locally generated at the electronic device 10a, as shown. After the primary code 130 is aligned with the replica primary code 132, secondary code wipe off (e.g., removal) logic 133 may be employed. For example, as shown, the electronic device 10a may receive, from the navigating device 10c and via a second antenna 55B, a second signal 134 indicative of a secondary code boundary of the secondary code 131. In some embodiments, the second signal 134 may include data relating to time tagged space vehicle (SV) information and/or other information (e.g., all time tagged SV information for multiple SVs, associated GNSS time, and local clock correction data), which is received at a secondary code translation unit 136. The secondary code translation unit 136 may employ the above-described information to determine the secondary code boundary. Additional details regarding the generation, transmission, and processing of the second signal 134 will be described in detail with reference to FIG. 6.

The secondary code wipe off (e.g., removal) logic 133 may be employed to wipe off, remove, or extract the secondary code 131 from the first signal 120 based on the secondary code boundary determined by the electronic device 10a via the second signal 134 received from the navigating device 10c. After the secondary code is wiped off, removed, or extracted from the first signal 120, coherent integration logic 137 may perform coherent integration based of the primary code 130 to identify various information employed by the electronic device 10a to determine a geographic position thereof, such as a time of transmission (TOT) of the first signal 120 from the transmitter device 102 of the GNSS 100, a time of arrival (TOA) of the first signal 120 at the electronic device 10a, a time difference between the TOT and the TOA, a distance between the transmitter device 102 and the electronic device 10a, and/or location information of the transmitter device 102. For example, the coherent integration logic 137 may produce a peak 138 (e.g., on a frequency search and code phase/chip search plot) indicative of certain of the above-described information. As previously described, removing the secondary code 131 may enable a longer coherent integration than in traditional embodiments, which enables signal acquisition and signal processing of signals having relatively low signal strengths.

As previously described, the electronic device 10a may perform the above-described processing steps and/or other processing steps with respect to multiple transmitter devices of the GNSS 100 until the electronic device 10a determines a suitable amount of information for ascertaining a geographic position of the electronic device 10a. As an example, the electronic device 10a may determine its geographic position based on a first distance between the electronic device 10a and a first transmitter device, a second distance between the electronic device 10a and a second transmitter device of the GNSS 100, a third distance between the electronic device 10a and a third transmitter device of the GNSS 100, and a fourth distance between the electronic device 10a and a fourth transmitter device of the GNSS 100. Information indicative of the locations of the various transmitter devices of the GNSS 100 may also be employed. Further, additional distances and corresponding transmitter devices may be employed to increase an accuracy of the geographic position determined by the electronic device 10a. Further still, in some embodiments, the electronic device 10a may be capable of determining its geographic position based on a GNSS synchronized atomic clock and distances from only three transmitter devices of the GNSS 100. After determining its geographic position, the electronic device 10a may output its geographic position (e.g., to a display of the electronic device 10a or some other source). Further, it should also be noted that the electronic device 10a may ultimately act as a navigating device with respect to another electronic device by sharing a signal indicative of a secondary code boundary (e.g., having time tagged SV information). In other words, while the electronic device 10a receives the second signal 134 from the navigating device 10c in the illustrated embodiment, at a later stage, the electronic device 10a may transmit its own iteration of the second signal 134 to another electronic device. It should be noted that FIG. 5 is provided merely as an example of embodiments of the present disclosure. For example, in other embodiments, various chronological descriptions of various processing steps above may be different.

FIG. 6 is a schematic illustration of an embodiment of a communicative coupling or interaction between the electronic device 10a and the navigating device 10c described above with respect to FIG. 5. A shown, the navigating device 10c may receive signals from a number of transmitter devices 102, 104, 106, 108 (e.g., space vehicles, satellites, etc.). For example, the navigating device 10c may receive the first signal 120 from the first transmitter device 102, a second signal 150 from the second transmitter device 104, a third signal 152 from the third transmitter device 106, and a fourth signal 154 from the fourth transmitter device 108. Based on the signals 120, 150, 152, 154, the navigating device 10c may determine its geographic position.

As previously described, the navigating device 10c may transmit the second signal 134 (e.g., facilitating signal) indicative of a secondary code boundary of a secondary code. As shown, the second signal 134 may include various data or information indicative of the secondary code boundary (e.g., various data or information that may be employed to identify or determine the secondary code boundary), such as time tagged SV information, associated GNSS time, and local clock correction. The first electronic device 10a may receive the second signal 134 and employ the second signal 134 to determine a secondary code boundary of a secondary code of a signal and wipe off, remove, or extract the secondary code from the signal. For example, as shown, the first electronic device 10a may receive the signal 120 corresponding to the first transmitter device 102 (or another signal 155 corresponding to a different transmitter device 109). Based on the secondary code boundary, the first electronic device 10a may wipe off, remove, or extract the secondary code from the signal 120 (or the signal 155) before performing coherent integration with respect to the primary code. In doing so, the coherent integration of present disclosed embodiments may be employed for acquiring and processing signals having weaker signal strength than is possible via traditional techniques, and/or the coherent integration may produce a more conclusive result than is possible via traditional techniques. In some embodiments, the secondary code boundary may be used to perform a time consistency check to prevent a class of attacks.

In general, embodiments of the present disclosure are directed toward a receiver device configured to process a signal broadcast by a transmitter device (e.g., a space vehicle, such as a satellite) of a Global Navigation Satellite System (GNSS) based at least in part on an additional signal received from an additional receiver device (e.g., navigating device) or an intermediate translation unit. That is, the receiver device may employ the additional signal to wipe off, remove, or extract a secondary code from the signal broadcast by the transmitter device to the receiver device. In this way, technical effects or benefits associated with embodiments of the present disclosure include acquisition of signals with relatively weak signal strength and/or enabling a longer coherent integration period, thereby enabling a more conclusive and/or accurate determination of a time of transmission (TOT) of the signal from the transmitter device, a time of arrival (TOA) of the signal at the receiver device, position information, or a combination thereof.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

1. A receiver device, comprising:
a first receiver configured to receive a first signal from a Global Navigation Satellite System (GNSS) satellite;
a second receiver configured to receive a second signal indicative of a secondary code boundary corresponding to a secondary code in the first signal from a second receiver device; and
processing circuitry configured to
receive a primary code by removing the secondary code from the first signal based on the secondary code boundary,
perform coherent integration on the primary code, and
output a geographic position of the receiver device based on the coherent integration.

2. The receiver device of claim 1, wherein the processing circuitry is configured to correlate the primary code with a replica primary code locally generated at the receiver device prior to removing the secondary code from the first signal based on the secondary code boundary, prior to performing the coherent integration, or prior to both.

3. The receiver device of claim 1, wherein the processing circuitry is configured to determine a time of transmission (TOT) of the first signal from the GNSS satellite, a time of arrival (TOA) of the first signal at the receiver device, or both based on the coherent integration.

4. The receiver device of claim 3, wherein the processing circuitry is configured to
determine a time difference between the TOT and the TOA, and
determine a distance between the receiver device and the GNSS satellite based on the time difference.

5. The receiver device of claim 4, wherein the processing circuitry is configured to determine the geographic position of the receiver device based on the distance, a second distance between the receiver device and a second GNSS satellite, a third distance between the receiver device and a third GNSS satellite, and a fourth distance between the receiver device and a fourth GNSS satellite.

6. The receiver device of claim 4, wherein the processing circuitry is configured to determine the geographic position of the receiver device based on the distance, a second distance between the receiver device and a second GNSS satellite, a third distance between the receiver device and a third GNSS satellite, and a GNSS synchronized atomic clock.

7. The receiver device of claim 1, wherein the processing circuitry is configured to receive the second signal from a navigating device or terrestrial base station, wherein the navigating device or terrestrial base station corresponds to the second receiver device.

8. The receiver device of claim 1, wherein the processing circuitry is configured to wipe off a carrier wave corresponding to the first signal prior to removing the secondary code from the first signal based on the secondary code boundary and prior to performing the coherent integration.

9. The receiver device of claim 1, wherein the processing circuitry is configured to transmit a third signal indicative of the secondary code boundary to a third receiver device.

10. The receiver device of claim 1, wherein the processing circuitry is configured to identify the GNSS satellite of a plurality of GNSS satellites based on the secondary code.

11. The receiver device of claim 1, wherein the processing circuitry is configured to identify a location of the GNSS satellite based on the coherent integration.

12. One or more tangible, non-transitory, computer-readable media storing instructions thereon that, when executed by one or more processors, are configured to cause the one or more processors to:
receive a first signal from a Global Navigation Satellite System (GNSS) satellite via a first antenna and a first receiver coupled to the first antenna;
receive a second signal indicative of a secondary code boundary corresponding to a secondary code in the first signal from a navigating device via a second antenna and a second receiver coupled to the second antenna;
receive a primary code of the first signal by removing the secondary code from the first signal based on the secondary code boundary; and
output a geographic position of a receiver device based on coherent integration of the primary code.

13. The one or more tangible, non-transitory, computer-readable media of claim 12, wherein the instructions, when executed by the one or more processors, are configured to cause the one or more processors to:
determine a time of transmission (TOT) of the first signal from the GNSS satellite, a time of arrival (TOA) of the first signal at the receiver device, or both based on the coherent integration; and
determine a distance between the GNSS satellite and the receiver device based on a time difference between the TOT and the TOA.

14. The one or more tangible, non-transitory, computer-readable media of claim 13, wherein the instructions, when executed by the one or more processors, are configured to cause the one or more processors to determine the geographic position of the receiver device based on the distance, a second distance between the receiver device and a second GNSS satellite, a third distance between the receiver device and a third GNSS satellite, and a fourth distance between the receiver device and a fourth GNSS satellite.

15. The one or more tangible, non-transitory, computer-readable media of claim 12, wherein the instructions, when executed by the one or more processors, are configured to cause the one or more processors to remove a carrier wave corresponding to the first signal based on a local oscillator signal.

16. The one or more tangible, non-transitory, computer-readable media of claim 12, wherein the instructions, when executed by the one or more processors, are configured to cause the one or more processors to transmit a third signal indicative of the secondary code boundary to an additional receiver device.

17. The one or more tangible, non-transitory, computer-readable media of claim 12, wherein the instructions, when executed by the one or more processors, are configured to cause the one or more processors to correlate the primary code of the first signal with a replica primary code.

18. A method, comprising:
receiving a plurality of signals transmitted by a plurality of Global Navigation Satellite System (GNSS) satellites via one or more antennas of a first electronic device and one or more receivers coupled to the one or more antennas;
determining a geographic position of the first electronic device based on the plurality of signals and via processing circuitry coupled to the one or more receivers; and
outputting, to a second electronic device, a facilitating signal including data indicative of a secondary code boundary of a secondary code corresponding to a signal of the plurality of signals.

19. The method of claim 18, comprising outputting, to the second electronic device, the facilitating signal including the data comprising time tagged satellite information corresponding to at least one satellite of the plurality of GNSS satellites, wherein the time tagged satellite information is indicative of the secondary code boundary.

20. The method of claim 18, comprising determining the geographic position of the first electronic device based on the plurality of signals and via the processing circuitry coupled to the one or more receivers by performing coherent integration on primary code corresponding to the plurality of signals.
